(19) United States
(12) Patent Application Publication
(10) Pub. No.: US 2009/0049738 A1
(43) Pub. Date: Feb. 26, 2009

(54) METHOD FOR THE PRODUCTION OF FUELS FROM BIOGENOUS RAW MATERIALS AND INSTALLATION AND CATALYST COMPOSITION FOR CARRYING OUT SAID METHOD

(75) Inventor: Emil A.J. Wiesert-Linhart, Salzburg (AT)

Correspondence Address: MARSHALL, GERSTEIN & BORUN LLP, 233 S. WACKER DRIVE, SUITE 6300, SEARS TOWER, CHICAGO, IL, 60606, US

(73) Assignee: LIGNOSOL GmbH & CO., AG, Grambach/Graz (AT)

(21) Appl. No.: 11/916,795

(22) PCT Filed: Jun. 6, 2006
(86) PCT No.: PCT/EP2006/005350

§ 371 Date: May 29, 2008

(30) Foreign Application Priority Data
Jun. 9, 2005 (CH) 098/05

(51) Int. Cl. C10L 1/00; B01J 21/12

(52) U.S. Cl. 44/307; 44/639; 502/240

(57) ABSTRACT

The invention relates to a method for producing fuel from biogenous raw materials, to an installation for carrying out said method, to catalyst compositions suitable for said method, and to the use of catalysts for producing fuel from biogenous raw materials.

The present invention relates to a method for the production of fuels from biogenous materials. It also relates to an installation for carrying out said method, catalyst compositions suitable for this method, as well as the use of catalysts to produce fuels from biogenous raw materials.

Various methods for producing fuels from raw materials have been proposed in the prior art.

One of the methods so proposed is the flash-pyrolysis of biomass in a hot-sand fluid bed, with subsequent rapid condensation of the resulting pyrolysis oils.

Another method that has been proposed is the so-called COREN method, which is a multi-stage process. The first stage consists of gasification by means of oxygen, the so-called Carbo-V method that is used to produce the synthesis gases (H₂, CO, CO₂). The second stage consists of synthesis gas purification and CO₂ washing. Fischer-Tropsch synthesis takes place in the third stage, and this ultimately leads to diesel by catalysis and condensation.

Also proposed is an air flow gasification method, according to which coke, pyrolysis gas, and pyrolysis oil are generated in an indirectly heated flow of inert gas, without catalysis, in a plurality of stages, with subsequent condensation.

DE 100 49 377 C2 describes a method for the conversion to oil of plastics, fats, oils, and other waste matter that contains hydrocarbons. When this is done, diesel can be produced with the help of a catalyst composed of sodium-aluminum silicate in a recirculating vaporizer, in circulation with a basic oil, which is ultimately separated by distillation and extracted thereby.

DE 199 41497 describes a device and a method for the catalytic conversion of wood to oil by smoldering, combustion of the smoldered residue, and combustion of the smoldered products in a container with honeycomb-type combustion catalysts at the upper end.

U.S. Pat. No. 4,648,965 describes a method for the production of liquid products from a feed stock that contains hydrocarbons that contain catalytically active constituents.

U.S. Pat. No. 4,038,172 describes a high-pressure method for processing feed stocks that contain oxygen, e.g., by using a red-clay catalyst composition in the presence of carbon monoxide.

However, these proposed methods entail various disadvantages.

The disadvantages of flash pyrolysis with subsequent condensation is the high reaction temperatures that are involved and the poor quality of the pyrolysis oils that are obtained. These contain excessive amounts of tar, oxygen, and water and are not suitable for use as fuels.

The CHOREN method calls requires a very complex and thus costly installation and provides a very small energy yield of approximately 40%. This results in extremely high operating costs that limit the method from the economic standpoint.

Because of the high temperatures that are required, the air flow gasification method generates a large quantity of gas and coke, although the oil yield is only half as great as the yield of obtained by the conversion of liquid to oil; in addition, the quality of the oil is unsatisfactory.

The catalytic circulating vaporizer method described in DE 100 49 377 C2 is not suitable for biomass (such as, for example, wood), since biomass contains only a few hydrocarbons and consists mainly of carbohydrates such as lignin and cellulose. In addition, biomass is not broken down sufficiently rapidly in the circulating method, and is thereby, to a great part, separated again by way of the disclosed solid-material lock. In addition to this, a fossil-base oil that has to be continually replenished is costly. In addition, the catalyst that is used, sodium aluminum silicate, (molecular sieve powder) is extremely expensive and thus increases the operating costs. A further disadvantage of this method is that, because of the method, the heating surfaces tends to become heavily coated when wood is used, so that economic operation is no longer possible. Finally, when wood is used as the raw material, economical utilization or disposal becomes problematic in the case of the recirculating vaporizer.

Because of the limited amounts of fossil fuels such as crude oil and natural gas, there is a need to generate fuels from renewable sources.

In particular, there is a need to produce fuels such as liquefied petroleum gas (LPG), diesel fuel, and gasoline from biomass, in particular from wood.

One objective of the present invention is to describe an alternative method and a corresponding installation for producing fuels from biogenous materials.

A further objective of the present invention is to describe a method for producing fuels from biogenous raw materials.

An additional objective is to create an installation for carrying out this method that does not entail the above-described disadvantages. It is of particular importance that i) the installation operates at moderate process temperatures, and/or ii) entails low operating cost and/or iii) is economical as a result of the improved yields that are obtained and/or iv) produces fuels that are of improved quality.

The objectives outlined above are achieved in accordance with the independent claims. The dependent claims describe advantageous embodiments.

Thus, the present invention relates to a method for producing fuels from biogenous raw materials.

The present invention also relates to an installation for producing fuels from biogenous raw materials.

The present invention also relates to a catalyst composition that is used in the above-quoted method.

The present invention also relates to the use of naturally occurring argillaceous earths as the catalysts used in the production of fuels from biogenous raw materials.

Provided that no other meaning results from the direct context, the following terms and expressions shall have the meanings described as follows:

Biogenous raw materials or biomass refers to regenerative vegetable raw material. Biomass can be obtained from trees or regenerative plants such as wood, tree trunks, in particular industrially valueless tree trunks, branches, broken wood, and waste wood obtained from wood processing installations, garden waste, and agricultural waste.

Fuels are known to the practitioners skilled in the art; the term refers in general to compounds and mixtures that contain hydrocarbon, such as those used in machines powered by internal combustion engines. The term also includes such materials and mixtures of materials that do not meet specific requirements for fuels but which are suitable as pre-products. In particular, the term refers to mixtures of materials that contain C6-C25 alkanes, C6-C25 alkenes, C3-C25 alkines, C3-C25 cycloalkanes and/or C6-C25 aromatics; these definitions also include alkyl-substituted compounds such as toluol or methyl cyclohexane, as well as branched compounds such as 2-ethyl hexane.

Carrier liquid or carrier oil refers to a liquid that is inert under reaction conditions. This liquid is able to hold the catalyst and the biogenous raw material in suspension. Heavy oil, which is generated continuously when the method according to the present invention is used, is a particularly suitable carrier liquid. Alternative carriers are heavy oil, diesel, or mixtures of these. The carrier liquid is in direct contact with the biogenous raw material and the catalyst during the method.

Thermo-oil refers to a liquid for indirect thermal transfer in the method according to the present invention. Suitable thermo-oils on known to the practitioner skilled in the art and can be based on silicon oils or hydrocarbons. Within the context of the present invention, any thermo-oils that are matched to the reaction temperature can be used. The thermo-oil is not in direct contact with the biogenous raw material or the catalyst during the method.

The term mineral catalyst or catalyst refers to a natural, mineral argillaceous earth that typically contains montmorriolite, illite and/or smectite. It is preferred that the argillaceous earth first be dried and finely ground. In a further preferred embodiment, the finely ground argillaceous earth is mixed with carrier liquid so that the catalyst is present in the form of a suspension (catalyst suspension). It is preferred that argillaceous earths that contain at least 50% mass-% of a bed silicate (preferably montmorriolite, illite and/or smectite) be used.

A first aspect of the present invention, a method for producing fuels from biogenous raw materials, is described in greater detail below.

The present invention relates to a method for producing fuels from biogenous raw materials, characterized in that a mineral catalyst of an argillaceous earth that contains montmorriolite, illite and/or smectite is caused to react with reduced biogenous raw material in a carrier liquid during heating, the resulting fuel being subsequently separated from the reaction mixture.

According to a preferred embodiment of the method, the mixture of reduced biogenous raw material and carrier liquid is subjected to a series of processing stages: softening of the raw material in a carrier liquid and heating by means of circulating carrier oil; further reduction of the raw material to form microfibers; mixing with the catalyst; further heating by means of circulating thermo-oil in order to break down the polymer structure of the cellulose and the lignin; still further heating by means of circulating thermo-oil to bring about deoxygenation and polymerization of the resulting monomers; still further heating by means of circulating thermo-oil in order to evaporate the resulting products; finally, graduated cooling of the vaporized products to form fuels.

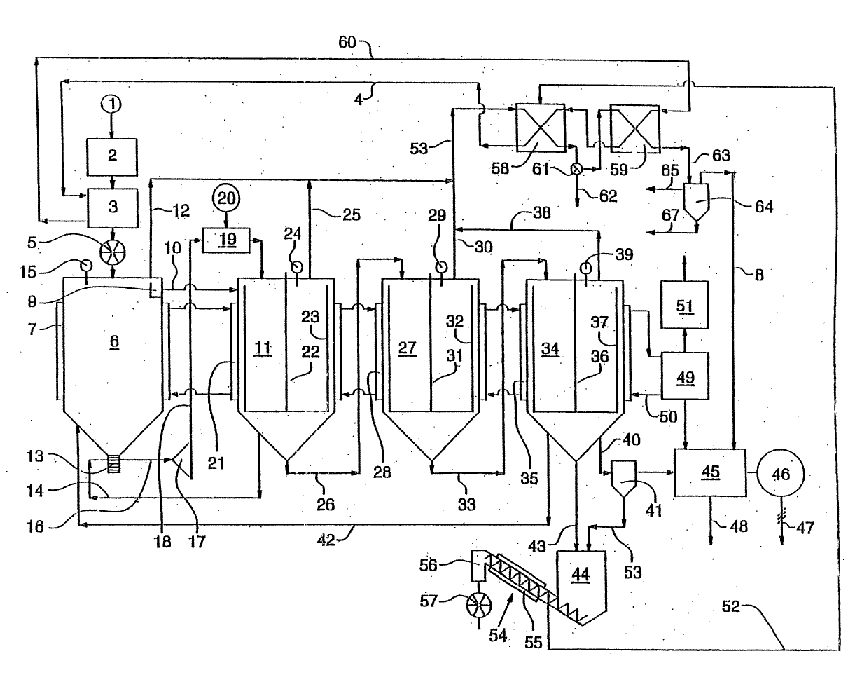

According to a further preferred embodiment, the method includes the following steps (for reference numbers, see FIG. 1): The biomass consisting of wood and/or regenerative plants is reduced in a crusher/grinder (2) and then dried in a dryer (3). The biomass is fed into a heated impregnation tank (6) and is mixed with the carrier liquid within this. In the direction of flow followed by the biomass that is to be processed, the impregnation tank (6) is followed by a further crusher/grinder (17). The biomass is mixed with a catalyst consisting of a natural mineral argillaceous earth in a mixer (19). The mixture is routed to a heated reaction tank (11), then into a heated maturation tank (27) and lastly into a heated evaporation tank (34). The gases and vapors that are formed in the tanks (4, 11, 27, 34) are condensed to form LPG/diesel and gasoline/water in two condensers (58, 59). The carrier liquid that remains in the evaporation tank (34) is routed as fuel through a separator (41) to a diesel engine of a block-type thermal power station (45) that drives a generator (46). Coarser solids that are separated out in a separator are freed of the heated carrier liquid in a heated removal screw (54) and removed. The flow of exhaust gas from the block type power station (45) is fed to a thermo-oil boiler (49) in which circulating thermo-oil for heating the tanks (6, 11, 27, 34) is heated.

A second aspect of the present invention, an installation for carrying out the above-described method, is described in greater detail below.

In one embodiment the installation according to the present invention includes the following:
a mixer (in which the catalyst is mixed into the carrier liquid with the reduced raw material), and
a heated reaction tank (in which, essentially, the polymer structure of the cellulose and the lignin of the cellulose of the biogenous raw material are broken down), followed by
a heated maturation tank (in which polymerization of the monomers generated in the reaction tank takes place), which is followed by
a heated evaporation tank (in which evaporation of the resulting products takes place).

In a preferred embodiment, the installation according to the present invention includes the following
a first crusher/grinder in which the biogenous raw materials that is fed in is reduced (in the case of wood, to chips)). This is followed by
a dryer, and this, in its turn, is followed by a heated impregnation tank that contains the carrier liquid (in which softening, soaking, and impregnation of the raw material feed stock in takes place); this impregnation tank is followed by
a second crusher/grinder that reduces the structure of the raw material to microfibers, and this second crushes/grinder is followed by
a mixer (in which the catalyst is added to the carrier liquid that contains the reduced raw materials), and this mixer is followed by
a heated reaction tank (within which the polymer structure and the lignin of the cellulose of the biogenous raw material is broken down and monomers are formed); this heated reaction tank is followed by
a heated maturation tank (in which polymerization of the monomers formed in the reaction tank takes place), and this heated maturation tank is followed by
a heated evaporation tank (in which evaporation of the products takes place) and this heated evaporation tank is followed by
a solids separator that is connected to
an internal combustion engine and is connected by way of a
heat exchanger that is connected through gas/vapor lines to the impregnation tank, to the reaction tank, to the maturation tank, and to the in evaporation tanks.

In a further embodiment, the installation according to the present invention comprises a first crusher/grinder to reduce the biogenous raw material, in particular wood to wood chips, that is fed in, which crusher/grinder is followed by a dryer that, in its turn, is followed by a heated impregnation tank that contains the carrier liquid, and within which softening, soaking, and impregnation of the raw material takes place, this impregnation tank being followed by a second crusher/grinder in which the structure of the raw material is reduced to microfibers; this second crusher/grinder is followed by mixer in which the catalyst is mixed into the carrier liquid with the reduced raw material; this mixer is followed by a heated reaction tank, in which the polymer structure and the lignin of the cellulose of the raw material is broken down; this heated reaction tank is followed by a heated maturation tank within which polymerization of the monomers formed in the reaction tank takes place, this heated maturation tank being followed by a heated evaporation tank in which evaporation of the resulting product takes place; this heated evaporation tank is connected through a solids separator to an internal combustion engine and through a heat exchanger that is connected through gas/vapor lines to the impregnation tank, to the reaction tank, to the maturation tank, and to the evaporation tank.

In a further preferred embodiment of the installation according to the present invention, the exhaust line from the internal combustion engine is routed to a thermo-oil waste-heat boiler for heat exchange with the circulating thermo-oil, and this is connected in sequence through a circulating heat line to one or a plurality of the following tanks in sequence: evaporation tank, maturation tank, reaction tank, and impregnation tank, in order to heat this/these tanks.

The installation according to the present invention can be either stationary or mobile.

A third aspect of the present invention, a new type of catalyst composition, is described in greater detail below.

The catalyst composition according to the present invention contains i) argillaceous earth that contains montmorriolite, illite and/or smectite and ii) carrier liquid. The ratio of argillaceous earth to carrier liquid can vary over a wide range. On the one hand, a high concentration of catalyst is desirable; on the other hand, simple and safe handling within the installation must be ensured. Typically, the catalyst composition contains 10-90%-mass argillaceous earth, preferably 20-75%-mass, for example 50%-mass.

High boiling point heavy oil is a suitable carrier liquid. It is preferred that the high boiling point heavy oil that is continuously formed when the method is carried out be used as a suitable carrier liquid.

It is preferred that the argillaceous earth contains 20-75%-mass montmorriolite, illite and/or smectite, preferably 50% %-mass montmorriolite, illite and/or smectite.

In an alternative embodiment, an argillaceous earth that contains other than the quoted bed silicates is used as the catalyst.

A fourth embodiment of the present invention, the use of argillaceous earths as catalysts will be described in great detail below.

The use of argillaceous earths that contain montmorriolite, illite and/or smectite in the conversion of biogenous raw materials to fuels has been described in great detail above. Up to now, the catalytic properties of argillaceous earths in this reaction have been unknown. Accordingly, in a further aspect, the present invention relates to the use of an argillaceous earths or compositions containing such earths in general during the conversion of biogenous raw materials to fuels.

FIG. 1 shows one example of an installation according to the present invention. The present invention, in particular the method and the installation, will be described in greater detail below with reference to FIG. 1.

In FIG. 1, the reference numbers refer to the following:
1 Source of raw material
2 Crusher/grinder
3 Dryer
4 Line to 3
   (60 Line from 3)
5 Cell-wheel lock
6 Impregnation tank
7 Annular chamber 6 for heating
8 Line to block-type thermal power station
9 Overflow
10 Overflow line
11 Reaction tank
12 Gas/vapor line from 6
13 Cell-wheel lock
14 Return line
15 Level sensor of 6
16 Line to 13
17 Additional, second crusher/grinder
18 Line to 19
19 Mixer
20 Catalyst source
21 Annular chamber of 11
22 Agitator element in 11
23 Wiper of 22
24 Level sensor of 11
25 Gas/vaporizer line from 11
26 Transfer line
27 Maturation tank
28 Annular chamber of 27
29 Level sensor of 27
30 Gas/vapor line from 27
31 Agitator element
32 Wiper of 31
33 Transfer line
34 Evaporation tank
35 Annular chamber of 34
36 Agitator element of 34
37 Washer of 36
38 Line from 34
39 Level sensor of 34
40 First outlet line from 34
41 Separator
42 Second outlet line from 34
43 Third outlet line from 34
44 Solids separator
45 Block-type thermal power station
46 Generator
47 Power generation
48 Cooling meter
49 Heat exchanger
50 Circulation line
51 Exhaust gas filter
52 Line to 58
53 Collector line
54 Removal screw
55 Heating system for 54
56 Cooler
57 Cell-wheel
58 First condenser
59 Second condenser
(60 Line from 3)
61 Liquids separator/aftercooler
62 LPG/diesel fraction
63 Line
64 Water separator
65 Gasoline line
67 Water exhaust line from 64

The number 1 refers to the source of raw material with the biogenous raw materials.

This biogenous raw material is placed in a first crusher/grinder 2. This can, for example, be a chopper, a shredder, or a mill in which the raw material feed stock is reduced to a granular size of 1-5 mm. In the case of wood, chips with dimensions within this range are formed.

Depending on the size of the installation, the throughput in the case of a mobile installation (for example, agriculture) can amount to 5 t of biogenous material per day. In the case of stationary installations, the throughput can amount to several thousand tons of biomass per day, although this will obviously depend on the dimensions of the overall installation with regards to its use.

The raw material that has been reduced is then routed into a dryer 3, within which the raw material is predried by hot air from a usual dry content of 50-60% to a dry substance content of 90-95%.

The warm air is routed to the dryer 3 through a line 4 that runs from a heat source (which is yet to be described), the exhaust air being returned through the line 62 to the heat source; the lines 4 and 60 together form a circulation line.

The raw material that has been reduced and pre-dried passes from the dryer 3 through appropriate transportation devices with, for example, conveyor belts or conveyor screws (not shown) into a cell-wheel lock. This cell-wheel lock 5 serves to prevent air from entering the following impregnation tank 6.

This impregnation tank 6 is formed with double walls around its periphery so as to form an annular chamber 7, and thermo-oil that is routed within the circulation system from a source (described below) passes through this annular chamber and thereby heats the impregnation tank 6. The operating temperature of the impregnation tank 6 lies within the range from approximately 120-150° C. Within the impregnation tank 6 there is a carrier liquid, e.g., a high boiling point heavy oil, that is routed within the circulation system. This carrier liquid, together with the raw material, is thus heated within the impregnation tank 6.

In addition, the impregnation tank 6 is equipped with a level sensor 15, and an overflow 9. An overflow line 10 runs to a subsequent reaction tank 11. In addition, a gas/vapor line 12 runs from the impregnation tank 6 to a further section of the installation (which is described below).

Essentially, softening, soaking, and impregnation of the biogenous raw material (e.g. the chips) takes place in the carrier liquid within this impregnation tank 6 that is indirectly heated by the thermo-oil. In addition to the actual softening, other processes, such as evaporation of the residual water, loosening of the wood structure by softening of the lignin, and the dissolution of volatile wood substances in the carrier liquid, may also take place. The water vapor and, if applicable, the gases that are generated leave the impregnation tank by way of the gas/vapor line 12.

Within the lower area of the impregnation tank 6 there is a further cell-wheel lock 13 that, as a through-flow lock, introduces the biogenous raw material (e.g., chips) into the flow of already heated carrier liquid that has been removed from the reaction tank 11 (which will be described below) by a pump (not shown herein). This flow of carrier liquid is routed from the reaction tank 11 through a return line 14.

The throughput of raw material is established by a variable-speed drive (not shown here-in) for the cell-wheel lock 13. The delivery of raw materials into the impregnation tank 6 is effected automatically, based on measurements of the level by the level sensor 15.

The biomass that emerges from the additional cell-wheel lock 13 is routed through a line 16 through the through flow of carrier liquid to a further—which is to say to a second—crusher/grinder 17, e.g., in the form of disperser, refiner, or ball mill, in which the structure of the biomass, which is to say of the chips, is reduced to the form of microfibers.

A line 18 runs from this second crusher/grinder to a mixer 19. The catalyst suspension is delivered to this mixer from a source 20.

Thus, this suspension is delivered to the mixer 19 from the source 20, and the biomass that has been reduced to microfibers is mixed with the added catalyst suspension in this mixer. The mixture flows from the mixer 19 into the reaction tank 11.

The reaction tank 11 is constructed with double walls around its periphery so that an annular chamber 21 is formed and thermo-oil that is routed within the circuit from a source (described below) flows through this annular chamber 21 and thereby heats the reaction tank 11.

The operating temperature of the reaction tank 11 lies within the range from approximately 150-250° C.

Within the reaction tank 11 there is an agitator element 22 that incorporates a wiper 23, so that the mixture that flows in from the mixer 19 is thoroughly mixed and, at the same time, it is ensured that the heating surfaces of the annular chamber 21 are kept clean.

The reaction tank 11 is equipped with a level sensor 24.

Within the heated reaction tank 11, the polymer structure of the cellulose and of the lignin of the biomass are broken down, primarily to individual molecules (monomers). At the same time, the separation of the ring structures on the oxygen atoms and the catalytic repositioning of the oxygen atoms (deoxygenation) directly onto the carbon monoxide CO that has been formed to CO₂ also begins.

These products leave the reaction tank 11 through the gas/vapor line 25 as gases. Other separation products remain dissolved either in the carrier liquid of the mixture or similarly leave the reaction tank in gaseous form through the gas/vapor line 25.

The extraction of the mixture, of the reaction fluid, by a pump (not shown here in) and the transfer line 26 from the reaction tank 11 to the following maturation tank 27 is controlled by the level sensor 24.

The maturation tank 7 is constructed with double walls around its periphery so that an annular chamber 28 is formed and thermo-oil that is routed within the circuit from a source (described below) flows through this annular chamber and thereby heats the maturation tank 27.

The operating temperature of the maturation tank is within the range from approximately 250-300° C.

There is also an agitator element 31 with an incorporated wiper 32 within the maturation tank 27, so that thorough mixing is ensured and at the same time the heating surfaces of the annular chamber 28 are kept clean

What essentially takes place within the maturation tank 27 is the conversion (polymerization) of the resulting monomers to C6-C25.

The resulting gases and vapors leave the maturation tank 27 through the gas/vapor line 30.

The maturation tank 27 it is equipped with a level sensor 29 that regulates the level within the maturation tank 27 by the controlled extraction of the mixture, of the reaction liquid, into the following evaporation tank 34; it does this by way of a pump (not shown herein) and the transfer line 33.

The evaporation tank 34 is constructed with double walls around its periphery, so that an annular chamber 35 is formed, and thermo-oil that is routed within the circuit from a source (described below) flows through this annular chamber and thereby heats the evaporation tank 34.

The operating temperature of the evaporation tank 34 lies within the range from approximately 300-370° C.

The evaporation tank 36 is similarly fitted with an agitator element 36 with an incorporated wiper 37.

The evaporation tank 34 provides for the final evaporation of the resulting products, as well as the completion of the catalytic polymer reactions. The evaporated products leave the evaporation tank 34 by way of the line 38. Evaporation tank 34 is equipped with a level sensor 39 which, in this case, controls the temperature, and thus the amount, of evaporation.

Depending on the biogenous raw materials that are used and on the process parameters, the number of required processing steps can vary from four (as described herein) from a minimal three to even six in the maximum case.

If, as a function of the raw material that is used, the sulphur content of the fuel that is produced is too high, dedicated, separate desulfurizing can be provided in the fuel condensates. These are known in the prior art.

Three outlet lines (40, 42, 43) are connected to the lower part of the evaporation tank 34.

The first outlet line 40 passes a first portion of the carrier liquid to a separator 41. The second outlet line 42 passes returns a second portion of the carrier liquid to the impregnation tank 6 through a pump (not shown herein) that serves as a return line. The third outlet line 43 runs to a solids separator 44.

Within the separator 41, particles that are of a greater size than 10-40μ are separated out through a suitable device (e.g., a filter or a centrifuge). The particles that are separated out are routed to the solids separator 44.

The carrier liquid with the remaining particles that are smaller than 10-20μ, and high boiling point heavy oil that is not vaporized in the evaporation tank 34, are fed as a fuel to a block-type thermal power station 45. This power station 45 incorporates a low-speed diesel engine. The very fine carbon particles in the carrier liquid thus pass to a great extent into the injection system of the block-type thermal power station 45 and are burned in the combustion chambers of the diesel engine and thus utilized as energy.

The low-speed diesel engine of the block type thermal power station 45 is suitable for carbon slurry operation and drives a generator 46 to generate power for the energy requirements of the installation, and to deliver power to the public grid. The cooling water 48 from the diesel engine is used for external heating purposes. The exhaust gases from the diesel engine, which are at a temperature of approximately 400° C., are routed to a thermal-oil boiler. Within the thermo-oil boiler 49, heat is transferred from the exhaust gases to the thermo-oil.

The heated thermo-oil then passes in sequence through a pump (not shown herein) and a circulation line to the annular chamber 35 of the evaporation tank 34, to the annular chamber 28 of the maturation tank 27, to the annular chamber 21 of the reaction tank 11 and to the annular chamber 7 of the impregnation tank 6. It then flows, in reverse sequence, through these annular chambers and back to the thermo-oil boiler 49. Thus, the tanks 6, 11, 27 and 34 of the installation are heated by the heat generated in the block-type thermal power station 45, so that operation that is optional from the standpoint of thermal technology is ensured.

The exhaust gas that is cooled in the heat exchanger 49 is ultimately discharged to the atmosphere through an exhaust gas filter 51. The filter dust that is trapped in the exhaust gas filter 51 is disposed of in a landfill.

The third portion of the carrier liquid flows from the evaporation tank 14 through the third outlet line 43 to the solids separator 44, to which solids that are larger than 10μ and trapped in a separator 41 are also routed by way of the line 53.

Optionally, the separation and regeneration of the catalyst from the remaining solids can take place in a separate method, so that this can once again be returned to the process, with the result that the use of fresh catalyst is reduced.

The solids separator 44 consists of a sedimentation chamber and a heated removal screw 54. Here, all the resulting mineral residual materials, as well as the argillaceous earth that has been added, are freed from the adhering carrier liquid by the heated removal screw 54. The heater bears the number 55.

The material that has not been evaporated, which is to say the residual material, is cooled and, after cooling within the cooler 56, is extracted by the cell-wheel 57 for external disposal.

The oil vapor are that is formed in the solids separator 44 and the solids that are formed in heated removal screw 56 passes to a heat exchanger through the line 52; this heat exchanger incorporates a first condenser 58 and a second condenser 59.

The gas/vapor lines 12, 25, 30, 38 of the tanks 6, 11, 27, 34 open out into a collector line 53 that runs to the first condenser 58 of the heat exchanger.

The drying air of the dryer 3 is heated within this first condenser, which is formed as a plate-type or tube-type heat exchanger, and this air flows through the line 60, through the second condenser 59 and then through the first condenser 58, after which it passes through the line 4 back to the dryer 3.

Typically, this first condenser 58 operates with an output temperature of 160-200° C. This temperature is kept constant by regulation of the quantity of cooling medium, which is to say the drying air. The temperature that has been quoted establishes the separation point between LPG/diesel and gasoline/water. These are routed from the different tanks 6, 11, 27, 34 and to the removal screw 54 in the form of vapor or gas.

The condensate flowing from the first condenser 58 flows to a liquid separator/aftercooler 61 with the uncondensed gases. The LPG/diesel fraction 62 accumulates in this. This is then fine filtered and passed as fuel into a storage tank (not shown herein).

The gases that have not yet condensed in the liquid separator/aftercooler 61 are fed into the second condenser 59 and are cooled to approximately 30° C. within this. The remaining water vapor condenses in this together with the gasoline fraction. This fraction then passes through the line 63 into a water separator 64. Within the water separator 64 the gasoline and water separate statically because they are immiscible and because of their different densities.

The gasoline that is separated off is routed through the line 65, fine filtered, and passed to a storage tank for use as fuel.

The water that is separated off is routed through the line 67, subjected to external purification, and disposed of.

Finally, the gases that have not yet condensed, mainly CO₂ and CO, but also C1-C4 alkanes and N₂, pass through the line 8 for combustion air to the diesel engine of the block-type thermal power station.

The following example serves to further explain the present invention; it is not intended to restrict the present invention in any way.

### EXAMPLE

4 kg/h of wood chips (dry) and 200 g/h of argillaceous earth are fed into a batch-type installation and subjected to the method according to the present invention at 350° C. for 10 hours. The following are isolated (relative to the starting material in %-weight): 33-43% fuels; 15-20% carbon, 20-25% water, 15-20% gas (43% CO₂; 32% CO, 7% CH4, 9% N₂, 1% H₂). This corresponds to the following energy utilization (relative to the starting material=100%):70-80% fuels, approximately 20% carbon, approximately 5-10% gas. The data vary, amongst other things, because of the variability of the feed stock that is used

1. A method for the production of fuels from biogenous raw materials, characterized in that biogenous raw material that has been reduced and is in a carrier liquid is caused to react with a mineral catalyst of argillaceous earth, which contains montmorriolite, illite, and/or smectite, while being heated, and the resulting fuel is separated from the reaction mixture.

2. The method of claim 1, characterized in that the catalyst that is used is a suspension of carrier liquid and dry, finely ground argillaceous earth that contains montmorriolite, illite, and/or smectite.

3. The method of claim 2, characterized in that the catalyst in the form of the suspension is added to the reduced raw material in an amount that varies from 0.3-6.0% of the reduced raw material itself.

4. The method of claim 1, characterized in that a mixture of biogenous raw material, catalyst, and carrier liquid is subjected to processing stages at graduated temperatures to bring about thermo-catalytic liquefaction.

5. The method of claim 1, characterized in that gases and vapors formed during the processing stages are subjected to graduated condensation in order to obtain liquid fuels.

6. The method of claim 1, characterized in that the reduced biogenous raw material is dried immediately after reduction.

7. The method of claim 6, characterized in that drying is effected by means of heat recovered after subsequent condensation.

8. The method of claim 6, characterized in that the reduced biogenous raw material is subjected to the following sequence of processing stages:
a) Softening of the biogenous raw materials in a carrier liquid and heating by means of circulating thermo-oil;
b) Further reduction of the biogenous raw material to form microfibers;
c) Mixing with the catalyst;
d) Further heating by means of circulating thermo-oil in order to break down the polymer structure of the cellulose and of the lignin;
e) Still further heating by means of circulating thermo-oil in order to effect polymerization of the resulting monomers;
f) Still further heating by means of circulating thermo-oil in order to evaporate the resulting products;
g) Graduated cooling of the evaporated products to form fuels.

9. The method of claim 8, characterized in that vapors and gases escaping in the course of heating during stages a), d), e), and f) are routed to a heat exchanger.

10. The method of claim 8, characterized in that during stage a) the residual water is evaporated; the structure of the wood is loosened by softening of the lignin; the volatile wood substances in the carrier liquid are dissolved; and the resulting vapor is routed to a heat exchanger.

11. The method of claim 8, characterized in that during stage d), the decomposition of the polymer structure and of the lignin, primarily forms individual molecules and, in addition, separation of the ring structure on the oxygen atoms and the catalytic repositioning positioning of the oxygen atoms directly onto the CO to form CO₂ takes place, and the products that are in gaseous form and which do not react with the carrier liquid or are not soluble in it are routed to a heat exchanger.

12. The method of claim 8, characterized in that during stage e) the gaseous polymerization of the resulting monomers to C6-C25 alkanes takes place and the gaseous products that have not been dissolved in the carrier liquid are routed to a heat exchanger.

13. The method of claim 8, characterized in that during stage f), the resulting products are finally evaporated and subsequently routed to a heat exchanger together with escaping gases.

14. The method of claim 13, characterized in that during stage f), a portion of the carrier liquid is routed to a separator in which solids of a size that is greater than 10-20μ are separated out.

15. The method of claim 14, characterized in that the solids that are smaller than 10-20μ and which have not been separated out are routed as fuel to an internal combustion engine together with the designated portion of the carrier liquid, the fine ash that is formed in the internal combustion engine being separated out in a particle filter.

16. The method of claim 15, characterized in that the internal combustion engine is a diesel engine.

17. The method of claim 16, characterized in that the heating referred to in claim 1 is effected by means of a circulating thermo-oil, and in that the exhaust gases from the internal combustion engine are routed to a thermo-oil heating boiler for heat exchange with the circulating thermo-oil.

18. The method of claim 8, characterized in that a second portion of the carrier liquid remaining during stage f) is fed back within the circuit for heating as in stage a).

19. The method of claim 8, characterized in that a third portion of the carrier liquid remaining during stage f) is routed to a solids separator, the solids separated out in a separator as described in claim 13 also being routed to this solids separator, after which the existing argillaceous earth and the resulting mineral solids are freed of the residual carrier liquid that is present by heating and by evaporation of the same.

20. The method of claim 17, characterized in that after flowing through the thermo-oil heating boiler, the exhaust gases are filtered and discharged to the environment

21. The method of claim 9, characterized in that heat exchange between the vapors and the raw material takes place in the heat exchanger, by means of which the raw material is dried as in claim 5.

22. The method of claim 10, characterized in that the heat exchanger incorporates a first section through which drying air flows as in claim 16, said section operating at an output temperature in the range from 160-200° C. and establishing the separation point between LPG/diesel and gasoline/water, from which first section the condensate and the uncondensed gases, including water vapor, are routed to a liquids separator/aftercooler in which the LPG/diesel fraction of the condensate is separated out, the as-yet uncondensed gases with the water vapor they contain being routed to a second section of the heat exchanger through which drying air flows as in claim 20, and which operates at an output temperature of approximately 30° C., in which the residual gases together with the water vapor condenses, after which the condensate is routed to a water separator to separate the gasoline from the water vapor.

23. The method of in claim 8, characterized in that the processing stage a) is carried out in a temperature range from approximately 120-150° C.; processing stage d) is carried out in a temperature range from approximately 150-250° C.; processing stage e) is carried out in a temperature range from 250-300° C.; and processing stage f) is carried out in a temperature range from approximately 300-370° C.

24. The method of claim 1, characterized in that the carrier liquid is a high boiling point heavy oil that is continuously generated in the installation and is burned continuously in the diesel engine as fuel.

25. An apparatus for carrying out the method as defined in claim 1, characterized by first crusher/grinder that reduces the biogenous raw material feed stock, said crusher/grinder is followed by a dryer, which dryer is, in its turn, followed by a heated impregnation tank that contains heated carrier liquid, and in which softening, soaking, and impregnation of the raw materials is effected; said impregnation tank is followed by a second crusher/grinder in which the structure of the raw material is reduced it to microfibers; said second crusher/grinder is followed by mixer in which the catalyst is mixed into the carrier liquid with the reduced raw material, said mixer being followed by a heated reaction tank in which the polymer structure and the lignin of the cellulose of the raw material is broken down; said heated reaction tank is followed by a heated maturation tank in which the polymerization of the monomers that result in the reaction tank takes place, said heated maturation tank being followed by a heated evaporation tank in which evaporation of the resulting product takes place, said heated evaporation tank being connected through a separator to an internal combustion engine of a block-type thermal power station and through a heat exchanger that is connected through gas/vapor lines to the impregnation tank, to the reaction tank, to the maturation tank and to the evaporation tank.

26. The apparatus of claim 25, characterized in that a first cell-wheel lock is disposed at the entrance to the impregnation tank and a second cell-wheel lock is disposed at the outlet of the impregnation tank, said second cell-wheel lock being followed by the second crusher/grinder that is connected to the mixer that, in its turn, is connected to the reaction tank.

27. The apparatus of claim 25, characterized in that the evaporation tank is connected to a separator to which a first portion of the carrier liquid is routed, said separator being connected through a feed line to a diesel engine, through which feed line solids that are smaller than 10μ together with the first portion of carrier liquid referred to above can be routed to the diesel engine.

28. The apparatus of claim 25, characterized by a return line that runs from the evaporation tank to the impregnation tank in order to return a second portion of the carrier liquid from the evaporation tank to the impregnation tank.

29. The apparatus of claim 27, characterized in that the evaporation tank is also connected to a solids separator that, on the input side, is connected through a first transfer line for routing solids which are larger than 10-20μ from the separator, said solids separator being connected through a second transfer line for routing a second portion of the carrier liquid from the evaporation tank, said solids separator being followed by a heated removal screw in which carrier liquid adhering to the mineral solids and the argillaceous earth is evaporated.

30. The apparatus of claim 27, characterized in that the exhaust gas line of the diesel engine is routed to a thermo-oil heating boiler for heat exchange with circulating thermo-oil, said heating oil being routed through a circulating heating line to a series of heating areas for heating the evaporation tank, the maturation tank, the reaction tank, and the impregnation tank.

31. The apparatus of claim 25, characterized in that the heat exchanger incorporates a first and a second condenser section, drying air that is to be heated flowing through said condenses sections.

32. The apparatus of claim 25, characterized in that the second condenser section is connected on the inlet side for the drying air through a feed line to the drying air outlet of the dryer, the first condenser section is connected on the drying air inlet side to the drying air outlet of the second condenser section which is connected at the drying air outlet side through an exhaust line (4) to the drying air inlet of the dryer, and to which the gas/vapor lines coming from the tanks are routed.

33. The apparatus of claim 32, characterized in that the first condenser section is connected on the condensate side to a liquids separator/aftercooler in order to route the condensate that has been cooled to approximately 160-200° C. to said liquids separator/aftercooler that incorporates a first outlet for the egress of the LPG/diesel obtained in it.

34. The apparatus of claim 33, characterized in that the liquids separator/aftercooler incorporates a second outlet for the uncondensed gases/vapors, said outlet being connected to the inlet of the second condenser section that, on the condensate side, is connected to a water separator in order to separate the water in the condensate that has been cooled to approximately 30° C. from the gasoline that has been obtained.

35. An apparatus to produce fuels as defined in claim 1, comprising the following devices that follow each other in sequence: mixer, heated reaction tank; heated maturation tank; heated evaporation tank.

36. Catalyst composition containing carrier liquid and argillaceous earth that contains montmorriolite, illite, and/or smectite.

37. The method of claim 1 using a catalyst composition as defined in claim 36.

38. Use of argillaceous earth that contains montmorriolite, illite, and/or smectite as a catalyst in the production of fuels from biogenous raw materials.

39. The apparatus of claim 25 wherein the first crusher/grinder is capable of reducing wood to wood chips.
